(19) United States
(12) Patent Application Publication
(10) Pub. No.: US 2003/0029855 A1
(43) Pub. Date: Feb. 13, 2003

(54) Sheath type glowplug with ion current sensor and method for operation thereof

(76) Inventors: Christoph Haluschka, Klingenberg (DE); Juergen Arnold, Benningen (DE); Christoph Kern, Aspach (DE)

Correspondence Address: KENYON & KENYON, ONE BROADWAY, NEW YORK, NY, 10004, US

(21) Appl. No.: 10/088,933

(22) PCT Filed: Apr. 14, 2001
(86) PCT No.: PCT/DE01/01470

(30) Foreign Application Priority Data
Jun. 30, 2000 (DE) 10031893.2

(51) Int. Cl. F23Q 7/22

(52) U.S. Cl. 219/270; 219/267

(57) ABSTRACT

A sheathed element glow plug having an ionic current sensor and a method of operating such a sheathed element glow plug are provided. The sheathed element glow plug includes a housing and a rod-shaped heating element arranged in a concentric bore in the housing. The heating element has at least one insulation layer, a first feeder layer, and a second feeder layer, the first feeder layer and the second feeder layer being connected by a web on the combustion chamber-side end of the heating element, the first and second feeder layers and the web being made of an electrically conducting ceramic material, and the insulation layer being made of an electrically insulating ceramic material. The heating element has at least one ionic current detection electrode made of an electrically conducting ceramic material.

### BACKGROUND INFORMATION

The present invention relates to a ceramic sheathed element glow plug for diesel engines having an ionic current sensor according to the definition of the species of the first independent claim. Unexamined German Patent Application 34 28 371 has already described ceramic sheathed element glow plugs having a ceramic heating element. The ceramic heating element has an electrode made of a metallic material which is used to determine the electric conductivity of the ionized gas present in the combustion chamber of the internal combustion engine. The wall of the combustion chamber functions as the second electrode.

In addition, there are also known sheathed element glow plugs having a housing in which is situated a rod-shaped heating element in a concentric bore. The heating element here is composed of at least one insulation layer and a first feeder layer and a second feeder layer, the first and second feeder layers being connected by a web at the tip of the heating element on the combustion chamber end. The insulation layer is made of an electrically insulating ceramic material, and the first and second feeder layers as well as the web are made of an electrically conducting ceramic material.

### ADVANTAGES OF THE INVENTION

The ceramic sheathed element glow plug according to the present invention having the ionic current sensor with the features of the first independent claim has the advantage that the sheathed element glow plug having the ionic current sensor has a very simple design and is inexpensive to manufacture. It is also advantageous that the expansion coefficients of the individual layers are matched to one another.

Advantageous refinements of and improvements on the sheathed element glow plug having the ionic current sensor characterized in the main claim are possible through the measures characterized in the subclaims. A design of a sheathed element glow plug which is especially advantageous from a design standpoint may be achieved if the feeder layers function as an electrode for detecting the ionic current. It is advantageous if the electric terminals of the feeder layers are provided on the end of the heating element remote from the combustion chamber so that operation of the sheathed element glow plug as an ionic current sensor becomes possible. It is also advantageous to additionally provide an ionic current detection electrode which runs inside the insulation layer or is applied to the insulation layer because in this way glow operation and ionic current measurement may take place simultaneously. It has proven advantageous here for the ionic current detection electrode to be arranged laterally on the surface on the combustion chamber-side end of the heating element to thus guarantee a sufficient distance between the feeder layer and the ionic current detection electrode. It is also advantageous for the ionic current detection electrode to be continued to the end of the heating element on the combustion chamber side, because in this way it is possible to detect an ionic current in an area of the combustion chamber which is important for the combustion processes taking place in the combustion chamber. It is furthermore advantageous to use the ceramic composite structure described below for the various layers of the heating element whose conductivity and expansion coefficient are very highly adaptable. This is likewise true of the precursor composite materials described below.

It is furthermore advantageous for the sheathed element glow plug having the ionic current sensor to be operated according to different methods. It is advantageous for ionic current detection to take place in a different time window than the glow phase, because this permits accurate ionic current detection. It is also advantageous to provide the ionic current detection during the glow phase of the heating element, because it is interesting to also detect the combustion process in the startup phase of the internal combustion engine.

Additional advantages are derived from the following description of the embodiments.

### BRIEF DESCRIPTION OF THE DRAWING

Embodiments of the present invention are illustrated in the drawing and are explained in greater detail in the following description.

FIG. 1 shows a schematic diagram of a sheathed element glow plug according to the present invention having an ionic current sensor in a longitudinal section,

FIG. 2 shows a schematic diagram of the combustion chamber-side end of a sheathed element glow plug having an ionic current sensor in a longitudinal section,

FIG. 3 shows a schematic diagram of a heating element of a sheathed element glow plug according to the present invention having an ionic current sensor in cross section,

FIG. 4 shows a schematic diagram of an end remote from the combustion chamber in another embodiment of the sheathed element glow plug according to the present invention having an ionic current sensor in longitudinal section, and

FIGS. 5 and 6 each show a schematic longitudinal section through a combustion chamber-side end of a heating element of a sheathed element glow plug according to the present invention having an ionic current sensor.

### DESCRIPTION OF THE EMBODIMENTS

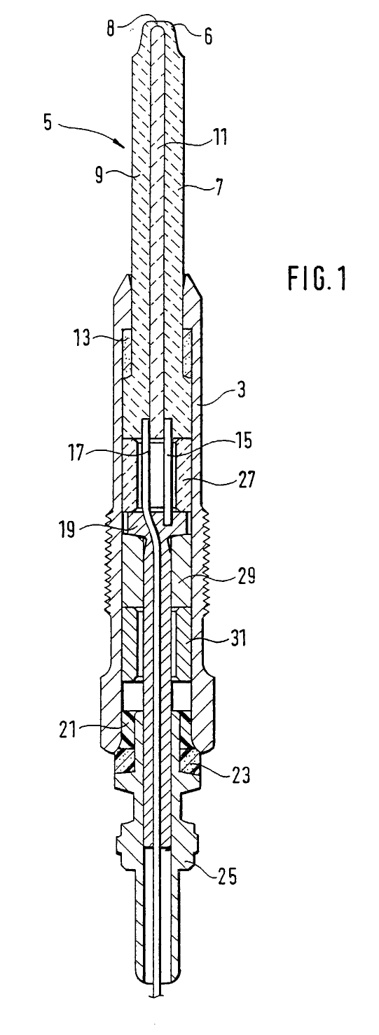

FIG. 1 shows a schematic diagram of a longitudinal section through a sheathed element glow plug according to the present invention. A tubular housing 3, preferably made of metal, holds a heating element 5 in its concentric bore on the combustion chamber-side end. Heating element 5 is made of a ceramic material. Heating element 5 has a first feeder layer 7 and a second feeder layer 9, first feeder layer 7 and second feeder layer 9 being made of an electrically conducting ceramic material. On end 6 of the heating element remote from the combustion chamber, first feeder layer 7 and second feeder layer 9 are connected by a web 8 which is also made of an electrically conducting ceramic material. First feeder layer 7 and second feeder layer 9 are separated by an insulation layer 11. Insulation layer 11 is made of an electrically insulating ceramic material. The interior of housing 3 is sealed in the direction of the combustion chamber by a combustion chamber seal 13 surrounding heating element 5 in a ring. On the end of heating element 5 remote from the combustion chamber, first feeder layer 7 is connected to a first terminal 15. This first terminal 15 is in turn connected to terminal stud 19 in the direction of the end of the sheathed element glow plug remote from the combustion chamber. Second feeder layer 9 is connected at its end remote from the combustion chamber to a second terminal 17 which passes through terminal stud 19 and continues to the end of the sheathed element glow plug remote from the combustion chamber, second terminal 17 being electrically insulated from the terminal stud. Terminal stud 19 is kept at a distance from the end of heating element 5 remote from the combustion chamber by a ceramic spacer sleeve 27 situated in the concentric bore of housing 3. In the direction of the end remote from the combustion chamber, terminal stud 19 passes through a tension sleeve 29 and a metal sleeve 31. On the end of the sheathed element glow plug remote from the combustion chamber, a round plug 25 is attached to terminal stud 19, establishing the electric connection. The end of the concentric bore of housing 3 remote from the combustion chamber is sealed and electrically insulated by a hose ring 21 and an insulation disc 23.

In this embodiment the sheathed element glow plug is operated so that the sheathed element glow plug is first operated in the heating mode in starting up the internal combustion engine. This means that during the glow phase, a positive voltage is applied to first terminal 15 and a negative voltage is applied to second terminal 17 or vice versa, so that a current flows across first feeder layer 17, web 8 and second feeder layer 9. The electric resistance along this path raises the temperature of the heating element and the combustion chamber into which the end of the sheathed element glow plug on the combustion chamber side protrudes, and thus the plug is heated. Heating element 5 is glazed on its end remote from the combustion chamber beyond the combustion chamber edge of housing 3, so that there is no electric contact between first or second feeder layers and housing 3.

After the end of the glow phase, the same high voltage potential is applied to first terminal 15 and second terminal 17 so that no more current flows in the feeder layers, but first feeder layer 7 and second feeder layer 9 function as the ionic current measurement electrode. If the combustion chamber is ionized by the presence of ions, an ionic current may flow from the ionic current detection electrode, i.e., from first feeder layer 7 and second feeder layer 9, to the wall of the combustion chamber which is at ground. Thus in this embodiment, first feeder layer 7 and second feeder layer 9 function as an ionic current detection electrode.

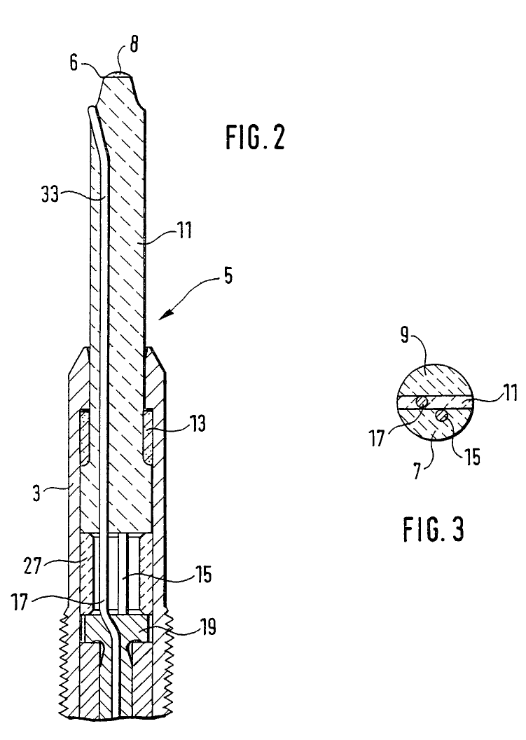

FIG. 2 illustrates schematically another embodiment of a sheathed element glow plug according to the present invention having an ionic current sensor in a longitudinal section. In this case only the combustion chamber-side end of such a sheathed element glow plug is shown. The end of this sheathed element glow plug remote from the combustion chamber corresponds to the design in the embodiment according to FIG. 11. Heating element 5 is again arranged in a concentric bore in housing 3, which is preferably made of metal. Heating element 5 is again composed of a first feeder layer 7, a second feeder layer 9 and an insulation layer 11, the cross section of heating element 5 shown in this diagram being cut in a plane so that only insulation layer 11 is visible (this plane is perpendicular to the section plane of FIG. 1). Insulation layer 11 and first feeder layer 7, web 8 and second feeder layer 9 are again made of materials which were already mentioned in conjunction with FIG. 1. First feeder layer 7 is connected to a terminal stud 19 by a first terminal 15. Terminal stud 19 is again kept at a distance from the end of the heating element which is remote from the combustion chamber by a ceramic spacer sleeve 27. The combustion chamber-side sealing of the interior of metallic housing 3 is again accomplished by a combustion chamber seal 13, which in this embodiment is made of an electrically conducting material because the second feeder layer is connected to ground via combustion chamber seal 13 to housing 3. A glazing applied on the outside to the surface of the first feeder layer in the area of housing 3 and combustion chamber seal 13 prevents first feeder layer 7 from contacting combustion chamber seal 13 and housing 3.

In this embodiment, an ionic current detection electrode 33, running from the end of heating element 5 remote from the combustion chamber to tip 6 of heating element 5 near the combustion chamber, is provided in insulation layer 11. Ionic current detection electrode 33 runs laterally on the surface of heating element 5 at tip 6 on the combustion chamber side.

Ionic current detection electrode 33 is made of an electrically conducting ceramic material or a metallic material. The end of the ionic current detection electrode which is remote from the combustion chamber is connected to a second terminal 17 which runs through terminal stud 19 to the end of the sheathed element glow plug remote from the combustion chamber.

FIG. 3 shows a cross section through heating element 5, illustrating the arrangement of terminals in the individual layers of the heating element again in detail. The cross section shows an area on the end of heating element 5 remote, from the combustion chamber. First terminal 15 is connected to first feeder layer 7 while second terminal 17 is connected to the ionic current detection electrode which runs through insulation layer 11. In addition, second feeder layer 9 which has electric contact via electrically conducting combustion chamber seal 13 to housing 3, which is at ground, is also shown in an area situated further in the direction of the combustion chamber.

This embodiment has an especially great advantage inasmuch as the sheathed element glow plug may be operated in glow operation and as an ionic current detection device simultaneously. To do so, the voltage required for glow operation is applied to first feeder layer 7 via terminal stud 19 and first terminal 15, and the voltage required for ionic current detection is applied to ionic current detection electrode 33 via second terminal 17.

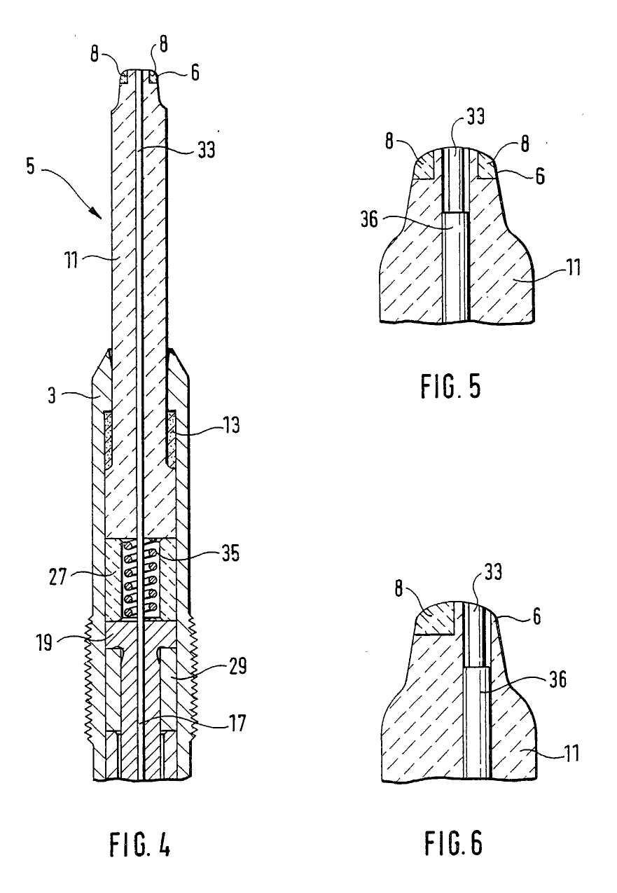

FIG. 4 illustrates another embodiment of a sheathed element glow plug having an ionic current sensor. By analogy with FIG. 3, the combustion chamber-side end of such a sheathed element glow plug is illustrated schematically in a longitudinal section. Heating element 5 is also shown sectioned in a plane in which only insulation 11 is visible, as in FIG. 2. The same reference numbers in this figure and in the following figures denote the same parts as in the preceding figures; therefore, they will not be discussed again here.

An ionic current detection electrode 33 again passes through the insulation layer, but this electrode extends to the outermost combustion chamber-side tip 13 of heating element 5. In contrast with the embodiment illustrated in FIG. 2, the electrode does not continue laterally beyond the surface of the heating element. Since ionic current detection electrode 33 now passes centrally through insulation layer 11, the connection to first terminal 17 is also centrally situated. In a preferred embodiment, first terminal 17 passes through a spring element 35 situated in a concentric bore in spacer sleeve 27, which is preferably insulated from spring element 35, and continuing through terminal 19 in the direction of the end of the sheathed element glow plug remote from the combustion chamber. Spring element 35 makes it possible to apply pressure to heating element 5 or terminal stud 19 and establishes the electric contact with first feeder layer 7, so that optimal electric contact and optimal sealing of the interior of housing 3 from the environment may be achieved by combustion chamber seal 13. The interior of housing 3 is sealed via spacer sleeve 27. The electric contact of second feeder layer 9 is designed like that in the embodiment described on the basis of FIG. 2.

In another embodiment, the terminals remote from the combustion chamber on first feeder layer 7 and on ionic current detection electrode 33 may also be designed without spring element 35 by analogy with FIG. 2.

On the basis of FIGS. 5 and 6, various embodiments of the design of combustion chamber-side tip 6 of heating element 5 are shown for the embodiment illustrated in FIG. 4. Each shows a longitudinal section through the combustion chamber-side tip of heating element 5.

FIG. 5 illustrates ionic current detection electrode 33 which runs to the combustion chamber-side tip of heating element 5 within insulation layer 11, which extends to combustion chamber-side tip 6 of heating element 5. First feeder layer 7 and second feeder layer 9 are connected by web 8 in only two areas, which are situated at a distance from the area in which ionic current detection electrode 33 extends up to combustion chamber-side tip 6 of the heating element 8 in the radial direction (with respect to the longitudinal axis through heating element 5, i.e., through the sheathed element glow plug). FIG. 5 also shows that in a preferred embodiment, the ionic current detection electrode is situated in an insulation sleeve 36 which extends almost to the combustion chamber-side end of the sheathed element glow plug.

FIG. 6 shows another embodiment in which ionic current detection electrode 33 continues laterally to combustion chamber-side tip 6 of heating element 5, and combustion chamber-side end 6 of heating element 5 has only one area in which first feeder layer 7 and second feeder layer 9 are connected by a web 8. The area in which web 8 is arranged in this embodiment is situated on the side of combustion chamber-side tip 6 of heating element 5 which does not have ionic current detection electrode 33. In this embodiment, the sheathed element glow plug is preferably situated in the combustion chamber, so that the side of combustion chamber-side tip 6 of heating element 5 on which web 8 is situated projects the greatest distance into the combustion chamber. This should be taken into account in particular in an arrangement when the sheathed element glow plug projects obliquely into the combustion chamber.

The embodiment illustrated on the basis of FIGS. 4, 5 and 6 preferably includes an ionic current detection electrode made of an electrically conducting ceramic material.

In another variant of the embodiments illustrated on the basis of FIGS. 2 through 6, ionic current detection electrode 33 may also be applied externally to insulation layer 11.

As mentioned above, the materials of first feeder layer 7, web 8, second feeder layer 9, insulation layer 11 and ionic current detection electrode 33 should be made of a ceramic material. This guarantees that the thermal expansion coefficients of the materials will hardly differ at all, thus guaranteeing the long-term stability of heating element 5. The material of first feeder layer 7, web 8 and second feeder layer 9 is selected so that the resistance of these layers is less than the resistance of insulation layer 11. Likewise, the resistance of first ionic current detection electrode 33 is less than the resistance of insulation layer 11.

In a preferred embodiment, first feeder layer 7, web 8 and second feeder layer 9, insulation layer 11 and first electrode 33 are made of ceramic composite structures containing at least two of the compounds Al₂O₃, MOSi₂, Si₃N₄ and Y₂O₃ . These composite structures are obtainable by a sintering operation in one or two steps. The specific resistance of the layers may be determined preferably on the basis of the MoSi₂ content and/or the core size of MoSi₂, the MoSi₂ content of first feeder layer 7, web 8 and second feeder layer 9 as well as first ionic current detection electrode 33 preferably being higher than the MoSi₂ content of insulation layer 11.

In another embodiment, first feeder layer 7, web 8 and second feeder layer 9, insulation layer 11, and first ionic current detection electrode 33 are made of a precursor ceramic having different filler contents. The matrix of this material is composed of polysiloxanes, polysequioxanes, polysilanes or polysilazanes which may be doped with boron, nitrogen or aluminum and are produced by pyrolysis. At least one of the compounds Al₂O₃, MoSi₂, SiO₂ and SiC forms the filler for the individual layers. By analogy with the composite structure described above, the MoSi₂content and/or the grain size of MoSi₂ may preferably determine the resistance of the layers. The MoSi₂ content of first feeder layer 7, web 8 and second feeder layer 9 as well as first ionic current detection electrode 33 is preferably higher than the MoSi₂ content of insulation layer 11. In the embodiments described above, the compositions of first feeder layer 7, web 8, second feeder layer 9, insulation layer 11 and first ionic current detection electrode 33 are selected so that their thermal expansion coefficients and the shrinkage that occurs during the sintering and pyrolysis process are the same, so that no cracks develop in heating element 5.

What is claimed is:

1. A sheathed element glow plug having an ionic current sensor having a housing (3) and a rod-shaped heating element (5) situated in a concentric bore in the housing (3), the heating element (5) having at least one insulation layer (11), a first feeder layer (7), and a second feeder layer (9); the first feeder layer (7) and the second feeder layer (9) being connected by a web (8) on the combustion chamber-side end (6) of the heating element (5), the first and second feeder layers (7, 9) and the web (8) being made of an electrically conducting ceramic material, and the insulation layer (11) being made of an electrically insulating ceramic material, the heating element (5) having at least one ionic current detection electrode (7, 9, 33),
wherein the at least one ionic current detection electrode (7, 9, 33) is made of an electrically conducting ceramic material.

2. The sheathed element glow plug according to claim 1, wherein at least one part of the first and/or second feeder layers (7, 9) functions as an ionic current detection electrode.

3. The sheathed element glow plug according to claim 2, wherein a first electric terminal (15) and a second electric terminal (17) are provided on the end of the heating element (6) remote from the combustion chamber, the first electric terminal (15) being connected to the end of the first feeder layer (7) remote from the combustion chamber, and the second electric terminal (17) being connected to the end of the second feeder layer (9) remote from the combustion chamber.

4. The sheathed element glow plug according to claim 1, wherein the ionic current detection electrode (33) runs inside the insulation layer (11) or is applied to the insulation layer (11).

5. The sheathed element glow plug according to claim 4, wherein the ionic current detection electrode (33) runs laterally on the surface of the heating element in the direction remote from the combustion chamber in front of the area in which the first and second feeder layers are connected to the combustion chamber-side end of the heating element (6).

6. The sheathed element glow plug according to claim 4, wherein the ionic current detection electrode (33) extends in the insulation layer (11) to the combustion chamber-side end (6) of the heating element (6), the insulation layer (11) running to the combustion chamber-side end (6) of the heating element (5).

7. The sheathed element glow plug according to one of claims 4 through 6,
wherein the first feeder layer (7) is connected on the end remote from the combustion chamber to a first electric terminal (15), and the end of the ionic current detection electrode (33) remote from the combustion chamber is connected to a second electric terminal (17).

8. The sheathed element glow plug according to one of claims 4 through 7,
wherein the second feeder layer (9) is connected to ground via the housing (3).

9. The sheathed element glow plug according to one of claims 1 through 8,
wherein a tubular spacer sleeve (27) made of an electrically insulating material is situated within the concentric bore of the housing (3) on the end of the heating element (6) remote from the combustion chamber.

10. The sheathed element glow plug according to one of claims 1 through 9,
wherein the insulation layer (11), the first feeder layer (7), the web (8), the second feeder layer (9) and the ionic current detection electrode (7, 9, 33) are made of ceramic composite structures accessible by a sintering operation in one or more steps using at least two of the compounds Al₂O₃, MoSi₂, Si₃N₄ and Y₂O₃.

11. The sheathed element glow plug according to one of claims 1 through 9,
wherein the insulation layer (11), the web (8), the first feeder layer (7), the second feeder layer (9) and the ionic current detection electrode (7, 9, 33) are made of a composite precursor ceramic, the matrix material including polysiloxanes, polysilsequioxanes, polysilanes or polysilazanes which may be doped with boron, nitrogen or aluminum and are produced by pyrolysis, the filler being formed from at least one of the compounds Al₂O₃, MoSi₂, SiO₂ and sic.

12. A method of operating a sheathed element glow plug having an ionic current sensor according to claim 1,
wherein during a glow phase, an electric voltage is applied to the first and second feeder layers (7, 9), the first feeder layer (7) and the second feeder layer (9) being connected to different voltage potentials, and an electric voltage having the same voltage potential is applied to the electrodes for ionic current detection (7, 9) after the end of the glow phase.

13. The method of operating a sheathed element glow plug having an ionic current sensor according to claim 1, wherein during the glow phase electric voltages having different voltage potentials are applied to the first and second feeder layers (7, 9) and at the same time to the ionic current detection electrode (33).
